(19) United States
(12) Patent Application Publication
(10) Pub. No.: US 2011/0275046 A1
(43) Pub. Date: Nov. 10, 2011

(54) METHOD AND SYSTEM FOR EVALUATING CONTENT

(76) Inventors: Andrew Grenville, Vancouver (CA); Tamara Pritchard, Vancouver (CA)

(21) Appl. No.: 12/777,170

(22) Filed: May 10, 2010

Related U.S. Application Data
(60) Provisional application No. 61/332,653, filed on May 7, 2010.

(51) Int. Cl. G09B 7/00

(52) U.S. Cl. 434/322

(57) ABSTRACT

The present disclosure describes methods, systems, and techniques for evaluating content, such as audio and video content. The content is presented to a respondent for evaluation. Feedback is collected from the respondent using a feedback collection device that presents different kinds of reactions to the respondent for selection during presentation of the content. Feedback is collected using a collection server and stored in a collection database. The feedback can be analyzed and summarized in a report to a pollster. Beneficially, the described methods, systems, and techniques allow for real-time collection of multiple respondent reactions, which facilitates accurate, efficient, and quick evaluation of the content.

### CROSS REFERENCE TO RELATED APPLICATION

This application claims the benefit of provisional U.S. Patent Application No. 61/332,653, filed May 7, 2010 and entitled “Method and System for Evaluating Content,” which is hereby incorporated by reference in its entirety.

### TECHNICAL FIELD

The present disclosure is directed at methods, systems, and techniques for evaluating content. More particularly, the present disclosure is directed at methods, systems, and techniques for evaluating content by collecting real-time feedback in the form of the presence or absence of various emotional reactions in respondents while the respondents are experiencing the content.

### BACKGROUND

Accurately evaluating content, such as audio and video content in the form of short audio and video clips, is becoming increasingly important. Such content can form the basis for expensive forms of advertising, political campaigns, television shows, and movies.

Consequently, misunderstanding how a potential market will perceive such content can lead to inefficient spending and lost profit. Traditional methods for evaluating content include questionnaires that are completed by respondents following exposure to the content; however, such methods can be slow, inefficient, and can lack accuracy.

### BRIEF DESCRIPTION OF THE DRAWINGS

In the accompanying drawings, which illustrate one or more exemplary embodiments:

FIG. 1 is a schematic of a system for evaluating content, according to a first embodiment.

FIG. 2 is a screenshot of a display of an example feedback collection device that forms part of the system of FIG. 1.

FIGS. 3 to 5 are exemplary feedback questions displayed on the example feedback collection device that forms part of the system of FIG. 1.

FIG. 6 is a screenshot of a display of an example pollster terminal that forms part of the system of FIG. 1, wherein the display is being used to report real-time results of how respondents evaluated the content.

FIGS. 7 to 11 are screenshots of the example display of the pollster terminal that forms part of the system of FIG. 1, wherein the display is being used to report results of how the respondents evaluated the content.

FIG. 12 is a method for evaluating content, according to a second embodiment.

### DETAILED DESCRIPTION

Often, a person (“pollster”) is interested in obtaining feedback from one or more persons (each a “respondent”) regarding a certain piece of content. The content may be audio, video or tactile in nature. For example, the content may be an audio or video recording, or may be a series of still photos. Conventional techniques for obtaining respondent feedback suffer from various drawbacks. For example, one conventional technique is known as “dial testing” and involves presenting each respondent with a rotatable dial that allows the respondent to indicate to what degree the respondent likes or dislikes the content as the respondent is experiencing the content. Unfortunately, dial testing only allows the respondent to indicate relative degrees of like or dislike.

Alternatively, the pollster can ask each respondent to answer a questionnaire after the respondent has experienced the content. Unfortunately, obtaining feedback in this way is problematic in that there is a delay between when the respondent experiences the content and when the respondent provides feedback. This delay can prejudice feedback accuracy.

Another technique for collecting feedback is to physically connect each respondent to sensors that record the respondent's biological responses to the content as the respondent is experiencing it. However, this technique is cumbersome for both the pollster and the respondent, and is unable to differentiate between the different types of reactions that the respondent may be experiencing.

The embodiments described herein describe methods, systems, and techniques that allow the pollster to solicit feedback from each respondent as the respondent is experiencing the content, and that allow the respondent to specify which of several reactions he or she may be having while experiencing the content. Consequently, the respondent is able to provide real-time feedback in that the feedback is provided while the respondent is experiencing the content, and is able to specify which of several emotions he or she is experiencing.

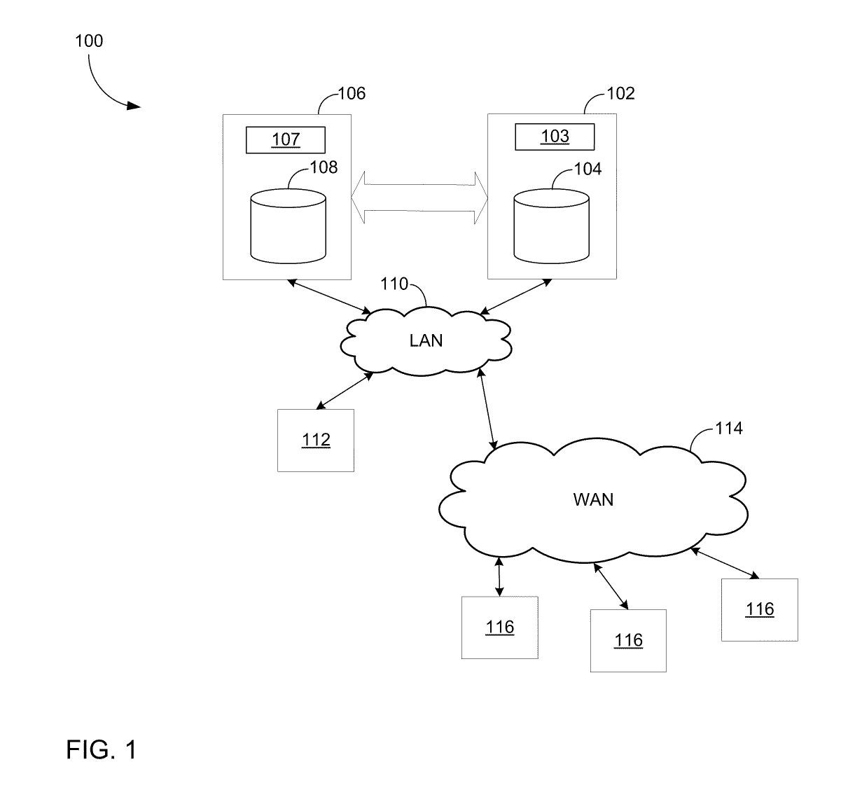

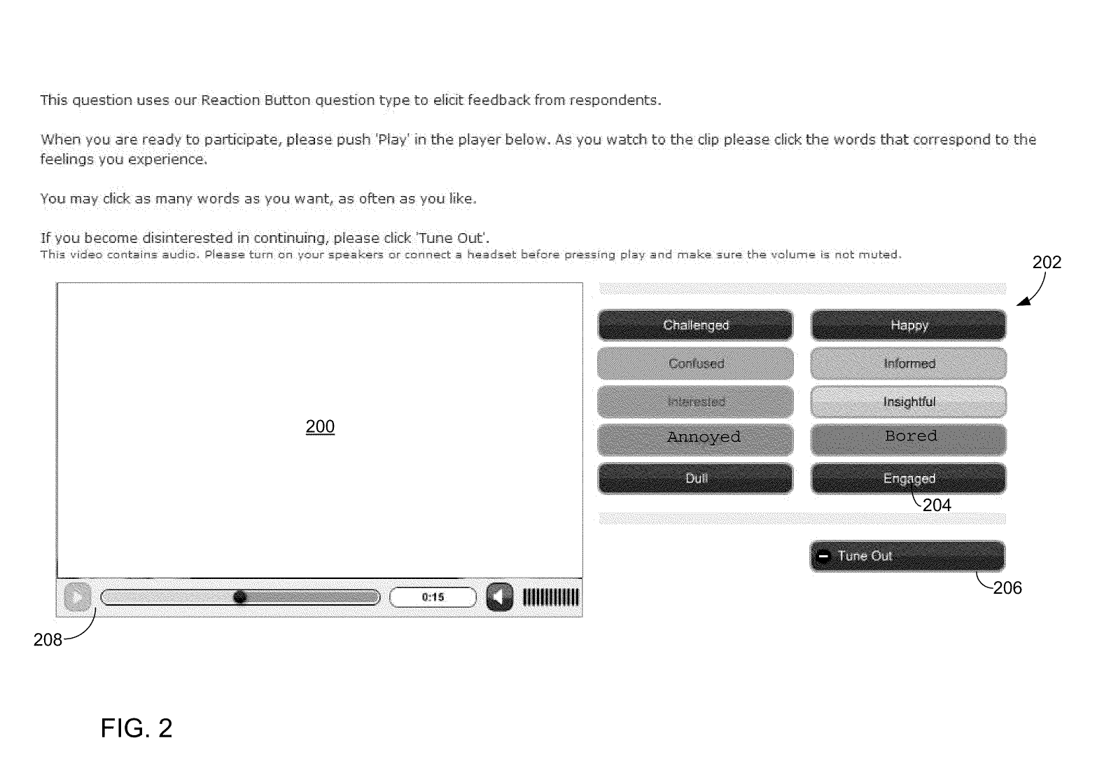

Referring now to FIG. 1, there is depicted one embodiment of a system 100 for evaluating content. The system 100 includes two servers: a feedback collection server 106 and a feedback reporting server 102 that are communicatively coupled to each other. Contained within the collection server 106 are a collection server memory 107 and a feedback collection database 108; similarly, contained within the reporting server 102 are a reporting server memory 103 and a feedback reporting database 104. As discussed in further detail below with respect to FIG. 2, the collection server 106 and the collection database 108 are responsible for presenting the content to the respondents and for collecting the respondents' feedback, while the reporting server 102 and the reporting database 104 are responsible for agglomerating the feedback from the respondents and reporting it in a coherent fashion to the pollster. The server memories 103, 107 each have encoded thereon statements and instructions for execution by processors (not shown) contained in each of the servers 102, 106 to cause the servers 102, 106 to perform as described, below. Each of the servers 102, 106 may be, for example, Microsoft™ Internet Information Services servers.

In the embodiment of FIG. 1, the collection server 106 and the reporting server 102 are both communicatively coupled to a local area network (LAN) 110. The LAN 110 may be, for example, an enterprise network used by the pollster. Also communicatively coupled to the LAN 110 is a pollster terminal 112. The pollster can use the pollster terminal 112 to upload the content to the collection server 106, to configure any surveys that will be used to obtain feedback from the respondents, and to retrieve agglomerated feedback from the reporting server 102.

The LAN 110 is networked with a wide area network (WAN) 114, such as the Internet. In the present embodiment, each of the respondents receive the content and provide their feedback using a feedback collection device 116. The feedback collection device 116 may be a personal computer connected to the WAN 114 and configured to interact with the collection server 106 using a web browser. Alternatively, the feedback collection device 116 may be a dedicated device such as a specially designed polling terminal, or a mobile device such as a smartphone. The feedback collection device 116 may also be web enabled to facilitate ease of use and feedback collection.

Referring now to FIG. 2, there is depicted what is displayed on an exemplary screen of the feedback collection device 116 when the feedback collection device 116 is, for example, a personal computer. FIG. 2 is displayed within a web browser window on a monitor that forms part of the personal computer, and the respondent interacts with the various controls illustrated in FIG. 2 using an input device such as a mouse. In the embodiment of FIG. 2, the respondent views video content through a viewing window 200; the video content is accompanied by an audio track. The respondent can play, pause and adjust the volume of the content using media controls 208. Adjacent to the viewing window 200 are ten reaction buttons 202, which prompt the respondent for feedback. Each of the reaction buttons 202 is labelled with a particular reaction 204. In the embodiment of FIG. 2, each of the reactions 204 are emotional reactions that the respondent may feel while watching the video content; specifically, the respondent may feel that the video content is any or all of challenging, confusing, interesting, annoying, dull, happy, informing, insightful, boring, and engaging. While in the present embodiment these particular ten reactions 204 are utilized, in alternative embodiments other reactions 204 may be utilized (e.g.: scared, surprised). Each of the reaction buttons 202 is selectable any number of times while the respondent is viewing the video content. Consequently, the feedback collection device 116 is able to collect feedback from the respondent in real-time while the respondent is viewing the video content, and the feedback includes information of any of a variety of reactions 204 that the respondent may be experiencing while watching the video content.

Given the continuous nature of video content, when the respondent selects one of the reaction buttons 202 it is likely that the reaction 204 the respondent is experiencing is relevant not only at the instantaneous moment the respondent selects the reaction button 202, but for a period of time after selection of the reaction button 202. Consequently, in the present embodiment, following selection of any of the reaction buttons 202 the reaction button 202 is highlighted and then fades, over a certain period of time (“reaction duration”), back to its default color. An exemplary reaction duration is five seconds. Highlighting the reaction button 202 informs the respondent that his or her selection of one of the reactions 204 persists for the reaction duration and that the respondent does not need to repeatedly select the reaction button 202 during the reaction duration to indicate that the respondent is continuing to experience the reaction 204. In FIG. 2, the “Insightful” reaction button has just been selected and is highlighted at full intensity, while each of the “Informed”, “Confused”, “Interested”, “Annoyed”, and “Bored” buttons have previously been selected at different times and are fading back to their default colors, and the “Challenged”, “Happy”, “Dull” and “Engaged” buttons have not been selected and are displayed using their default colors.

In alternative embodiments in which the feedback collection device 116 has a touch screen interface, the respondent may press and hold any of the reaction buttons 202 for as long as is appropriate. While in the present embodiment each of the reactions 204 is a type of emotional reaction, in an alternative embodiment the reactions 204 may be, for example, questions of fact (e.g.: “How many colours do you see flashing?”) or of opinion (e.g.: “Which candidate do you find more appealing?”). Additionally, although in the present embodiment each of the reaction buttons 202 allows only for binary input in that each button is either selected or unselected, in an alternative embodiment the reaction buttons 202 can allow the respondents to provide analog feedback. For example, the reaction buttons 202 can take the form of sliders; this embodiment is particularly advantageous when the feedback collection device 116 utilizes a touch screen to capture input.

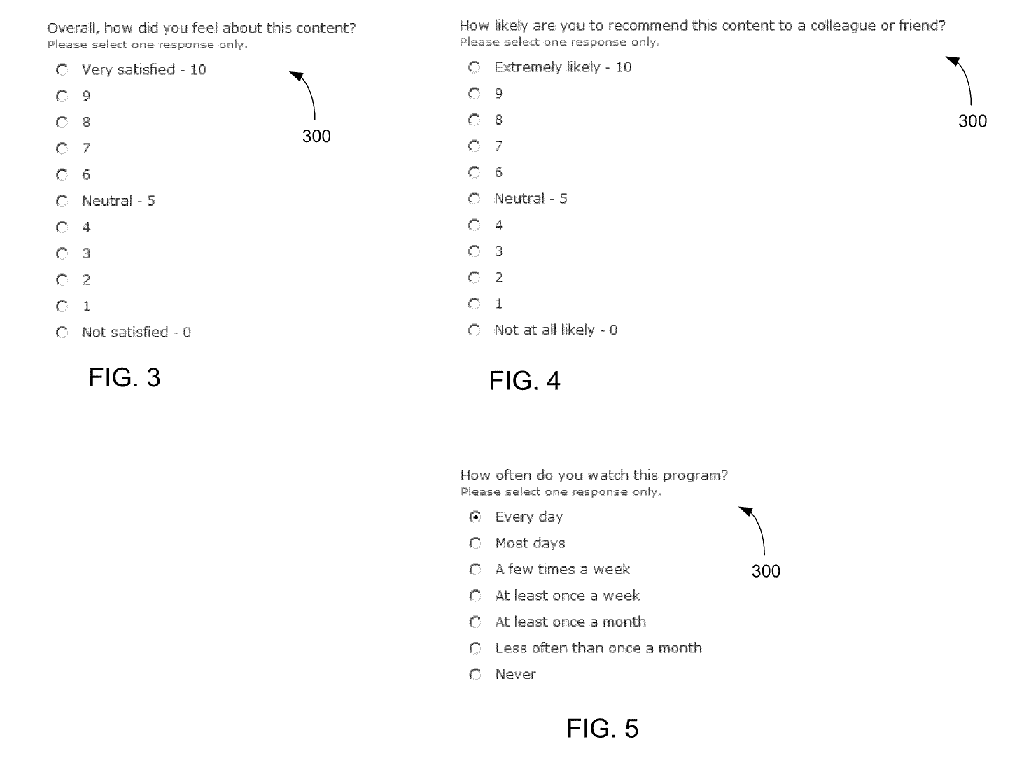

Referring now to FIGS. 3 to 5, following completion of the video content, the feedback collection device 116 proceeds to query the respondent with one or more feedback questions 300. Alternatively, the respondent may select a tune out button 206 at any time while the video content is being played, which immediately terminates the video content and presents the respondent with the feedback questions 300. While in the present embodiment the feedback questions 300 that are presented to the respondent are the same regardless of whether the tune out button 206 is pressed or whether the video content is played to completion, in an alternative embodiment the feedback questions 300 may differ depending on whether the tune out button 206 is pressed. For example, the feedback questions 300 may be customized to determine why the respondent apparently lost interest in the content when the tune out button 206 is pressed.

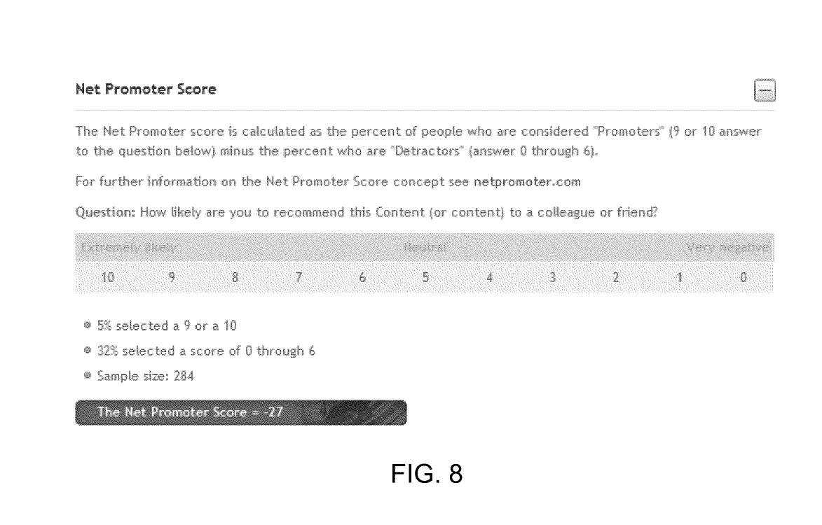

FIGS. 3 through 5 each depict examples of the feedback questions 300. In FIG. 3, the feedback question 300 queries the respondent about how the respondent felt about the content; in FIG. 4, the feedback question 300 queries the respondent about how likely the respondent is to recommend the content to a colleague or a friend; and in FIG. 5, the feedback question 300 queries the respondent as to how often the respondent watches the video content. The feedback question 300 of FIG. 5 may be particularly apposite when, for example, the video content is an excerpt from a weekly television program. As discussed in more detail below in respect of FIGS. 8 to 11, responses to the feedback questions 300 may be manipulated and analyzed in certain ways to generate innovative metrics directed at properly evaluating the content.

FIGS. 2 through 5 depict a “feedback collection phase” in which the collection server 106 presents content to the feedback collection devices 116, and in which the respondents provide feedback in the form of selecting the reaction buttons 202 and answering the feedback questions 300. In the present embodiment, the video content is streamed from the collection server 106 to the viewing window 200. The video content may be encoded in, for example, the H.264 standard and the viewing window 200 may be implemented using any suitable technology as is known to skilled persons, such as Flash™ or HTML5. When the respondents provide feedback, the collection server 106 stores the feedback in the collection database 108. In the present embodiment each piece of feedback is stored in the form of an XML formatted string. For example, each time the respondent makes any selection on the screen depicted in FIG. 2, one of the XML formatted strings is created. An exemplary XML formatted string follows:

<event>
<StepName>reaction_plus_1</StepName>
<Session>
<UrlVariables>session_data_to_identify_respondent<UrlVariables>
</Session>
<EventName>Reaction</EventName>
<PropertyGroup>

<Playback>50</Playback>
<Data>2</Data>

</PropertyGroup>
</event>

The data identified by the <Session> tag is session data that identifies the particular respondent providing the feedback. The data identified by the <EventName> tag is the type of selection that the respondent has made (e.g.: one of the reaction buttons 204 or the media controls 208). The data identified by the <Playback> tag is the playhead time at the moment the selection is made. The data identified by the <Data> tag is the data associated with the selection (e.g.: which of the reactions 202 has been selected).

This XML formatted string is transmitted and stored in the collection database 108 according to methods known to skilled persons. For example, Flash™ remoting or Javascript™ may be used. The collection database 108 stores the XML data until results are reported to the pollster. Notably, when Flash™ remoting is used, data can be passed to the collection database 108 as a generic object, as follows:
Event=new Event( )
Event.StepName=reaction_plus_{—}1
Event.Session.UrlVariables=session_data_to_identify_respondent
Event.EventName=Reaction
Event.PropertyGroup.Playback=50
Event.PropertyGroup.Data=2

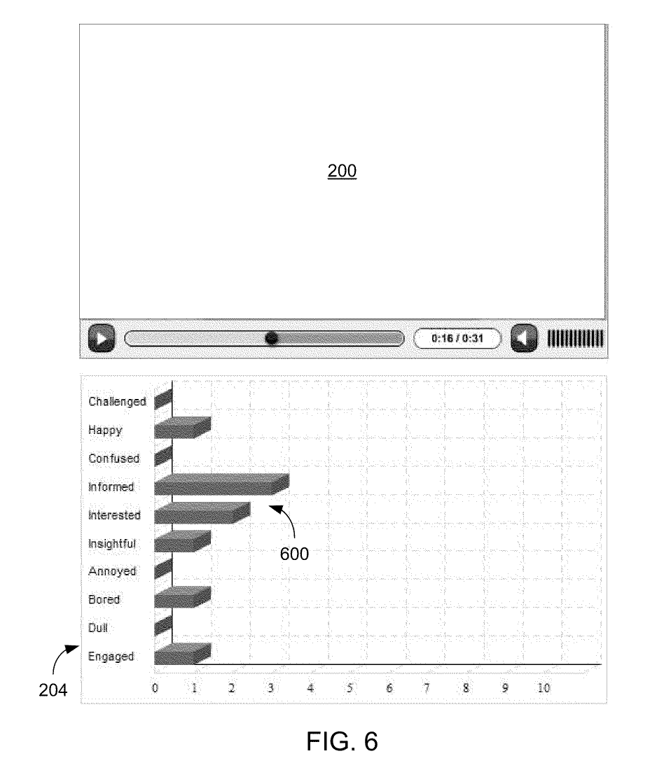

Results are reported to the pollster in the form of reports containing graphic displays as depicted in FIGS. 6 through 11. The reports of FIGS. 6 through 11 are computed and shown to the pollster via the pollster terminal 112 during a “feedback reporting phase”. While the collection of the feedback and the presentation of the content is handled by the collection server 106 and collection database 108, the reporting server 102 and the reporting database 104 are responsible for agglomerating the feedback stored in the collection database 108 and for generating the reports that are ultimately displayed to the pollster.

Prior to generating the reports, the collection server 106 accesses the collection database 108 and transfers the various XML files containing the feedback to the reporting server 102. The reporting server 102 agglomerates the various XML files into one XML file (“agglomerated XML file”) capturing all feedback obtained from all the respondents. An excerpt from an exemplary agglomerated XML file follows:

<?xml version=“1.0” ?>

| | |
|---|---|
| − | <ReactionReport xmlns:xsi=“http://www.w3.org/2001/XMLSchema- |

instance”
xmlns:xsd=“http://www.w3.org/2001/XMLSchema”>

| | |
|---|---|
| − | <ContentInfo> |
| | <InternalName>Hot Cities</InternalName> |
| | <Name>Hot Cities</Name> |
| | <Definition>a program about climate change</Definition> |
| | <Link>[video link.flv]</Link> |
| | <MediaType>Video</MediaType> |
| | <ContentId>1</ContentId> |
| | <PublishFrequency>Weekly</PublishFrequency> |
| | <Topic>General</Topic> |
| − | <MediaCategories> |
| | <MediaCategory>Factual/Documentary</MediaCategory> |
| | <MediaCategory>Science and Technology</MediaCategory> |

</MediaCategories>

| | |
|---|---|
| − | <Regions> |
| | <Region>Asia-Pacific</Region> |
| | <Region>South Asia</Region> |
| | <Region>Global</Region> |

</Regions>

<SampleSize>119</SampleSize>

</ContentInfo>

| | |
|---|---|
| − | <Descriptions> |
| | <Description Index=“0” Name=“Interested” /> |
| | <Description Index=“1” Name=“Happy” /> |
| | <Description Index=“2” Name=“Bored” /> |
| | <Description Index=“3” Name=“Annoyed” /> |
| | <Description Index=“4” Name=“Engaged” /> |
| | <Description Index=“5” Name=“Insightful” /> |
| | <Description Index=“6” Name=“Informed” /> |
| | <Description Index=“7” Name=“Confused” /> |
| | <Description Index=“8” Name=“Dull” /> |
| | <Description Index=“9” Name=“Challenged” /> |
| | </Descriptions> |
| − | <Reactions> |
| − | <Reaction Offset=“0” TuneOutCount=“0”> |
| − | <Counts> |
| | <int>0</int> |
| | <int>0</int> |
| | <int>0</int> |
| | <int>0</int> |
| | <int>0</int> |
| | <int>0</int> |
| | <int>0</int> |
| | <int>0</int> |
| | <int>0</int> |
| | <int>0</int> |

</Counts>

</Reaction>
...

| | |
|---|---|
| − | <Reaction Offset=“191” TuneOutCount=“33”> |
| − | <Counts> |
| | <int>6</int> |
| | <int>0</int> |
| | <int>0</int> |
| | <int>0</int> |
| | <int>2</int> |
| | <int>1</int> |
| | <int>7</int> |
| | <int>0</int> |
| | <int>0</int> |
| | <int>0</int> |

</Counts>
</Reaction>

| | |
|---|---|
| − | <Reaction Offset=“192” TuneOutCount=“33”> |
| − | <Counts> |
| | <int>6</int> |
| | <int>0</int> |
| | <int>0</int> |
| | <int>0</int> |
| | <int>2</int> |
| | <int>1</int> |
| | <int>7</int> |
| | <int>0</int> |
| | <int>0</int> |
| | <int>0</int> |

</Counts>

</Reaction>
...

| | |
|---|---|
| − | <Reaction Offset=“374” TuneOutCount=“57”> |
| − | <Counts> |
| | <int>0</int> |
| | <int>0</int> |
| | <int>0</int> |
| | <int>0</int> |
| | <int>0</int> |
| | <int>0</int> |
| | <int>0</int> |
| | <int>0</int> |
| | <int>0</int> |
| | <int>1</int> |

</Counts>
</Reaction>
</Reactions>

| | |
|---|---|
| − | <MaximumCounts> |
| | <int>17</int> |
| | <int>1</int> |
| | <int>8</int> |
| | <int>5</int> |
| | <int>8</int> |
| | <int>7</int> |
| | <int>16</int> |
| | <int>3</int> |
| | <int>6</int> |
| | <int>4</int> |

</MaximumCounts>

</ReactionReport>

In the above excerpt, all text prior to the <SampleSize> tag is bibliographic information related to the content being evaluated. The <SampleSize> tag is the number of respondents participating in evaluating the content. The <Description Index> tag describes the various reactions 204 that the respondents can indicate they are having while experiencing the content. The <Reaction Offset> tag is a time index that represents when, relative to the playhead time of the content, the respondents have provided the feedback. The difference between sequential <Reaction Offset> tags can be modified as necessary, with a suitable difference being one second. The integers following the <Counts> tag represent the number of times the respondents have selected the various reactions 204 at a particular time. The integers following the <MaximumCounts> tag at the end of the agglomerated XML file represent the total number of times the respondents have selected the various reactions 204. The reporting server 102 can access the agglomerated XML file and use it to generate the reports illustrated in FIGS. 6 through 11.

Referring now to FIG. 6, there is depicted a snapshot of one report provided to the pollster in which, as the video content plays in the viewing window 200, the pollster can see a real-time depiction of which of the reactions 204 the respondents were experiencing while watching the video content. In other words, while in FIG. 2 the respondents provide their feedback in response to the video content in real-time, in FIG. 6 the pollster sees the feedback from all the respondents in real-time.

In FIG. 6, a graph is depicted having multiple rows in which each of the rows is labelled using one of the reactions 204. In each of the rows is an animated indicator 600 that corresponds to how many of the respondents selected the reaction 204 associated with that row at the particular playhead time of the video content. For example, in the instance captured in FIG. 6, the playhead time of the video content is 16 seconds, and the row associated with the “Informed” reaction shows three selections. Consequently, of all the respondents who provided feedback, three felt that the video content at 16 seconds “informed” them. In the present embodiment, the reaction selection persists for the length of the reaction duration. Consequently, the three respondents who felt that the video content was “informing” at 16 seconds either selected the “Informed” reaction button 202 at 16 seconds while watching the content, or as long as the reaction duration before the 16 second mark of the video content. As the playhead time of the video content progresses, the animated indicator 600 will change accordingly. If, for example, at a playhead time of 25 seconds none of the respondents found the video content “informing”, the animated indicator 600 will indicate “zero” next to the “Informed” reaction 204 when the video content reaches the 25 second mark.

In the present embodiment, the reporting server 102 reports the presence of one of the reactions 204 once the respondent selects one of the reaction buttons 202 and for the reaction duration thereafter. In an alternative embodiment, the reporting server 102 takes into account a delay in the form of a reaction time between the moment the respondent experiences the reaction 204 and the moment the respondent actually selects the reaction button 202. For example, when the reaction time is one second, the respondent will experience a reaction at a playhead time of 15 seconds (e.g.: the respondent realizes, “This content is making me happy”), but takes one second to click the reaction button 202 labelled “Happy”. To compensate for the reaction time, the reporting server 102 in this alternative embodiment reports that the respondent is Happy from a playhead time of 15 seconds, and calculates the reaction duration as starting at a playhead time of 15 seconds.

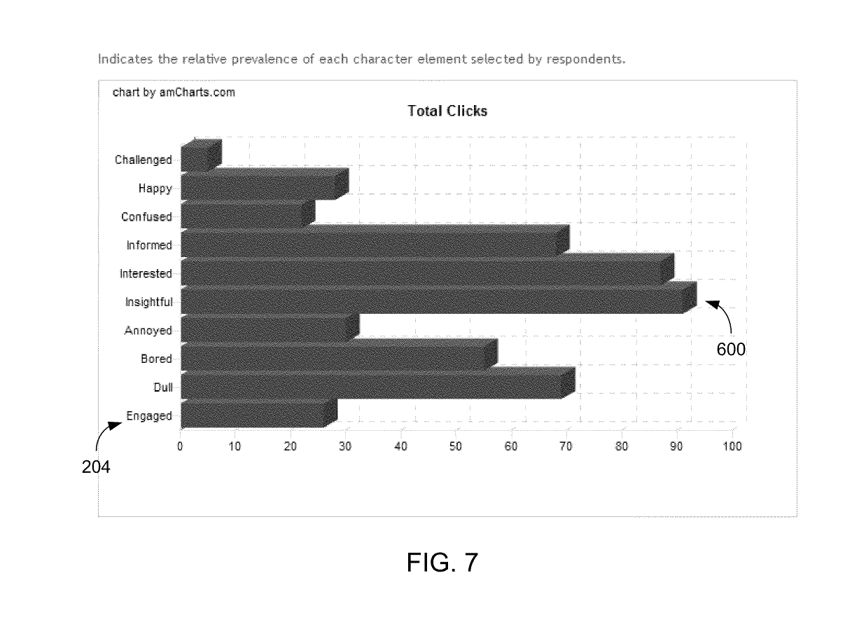

Referring now to FIG. 7, there is depicted a graph indicating the total number of selections of each of the reactions 204 by the respondents during the entirety of the video content. FIG. 7 is a graph of each of the reactions 204 vs. the information tagged using the <MaximumCounts> tag in the agglomerated XML file. For example, according to FIG. 7, about 91 people found some portion of the video content “insightful”.

Referring now to FIG. 8, there is depicted a “net promoter score” of the video content. In brief, the net promoter score represents a difference between those respondents who answer the feedback question 300 shown in FIG. 4 very positively with a 9 or a 10, indicating that they are likely to tell others about the video content, minus those respondents who answer the feedback question 300 from 0 to 6, indicating that they are unlikely to tell others about the video content. The higher the net promoter score, the more likely people are to view the video content because of word of mouth.

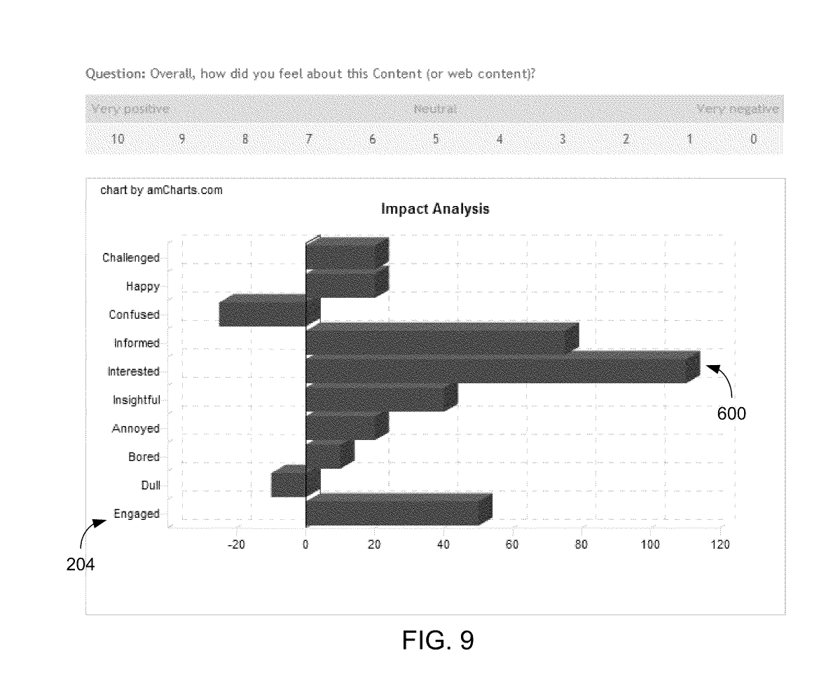

Referring now to FIG. 9, there is depicted a graph that depicts the importance of each of the various reactions 204 in driving the respondents' overall perception of the video content. Data from the feedback question 300 in FIG. 3 is used to generate the graph shown in FIG. 9. The feedback question 300 in FIG. 3 determines which of the respondents felt strongly that they enjoyed the video content (e.g.: they provided an answer to the feedback question 300 of FIG. 3 between 7 and 10) (“very positive respondents”), and which of the respondents felt strongly that they did not enjoy the video content (e.g.: they provided an answer to the feedback question 300 of FIG. 3 between 0 and 3) (“very negative respondents”). For each of the reactions 202, the impact score is the difference between the number of times the very positive respondents selected the reaction 202 and the number of times the very negative respondents selected the reaction 202. For example, in the graph of FIG. 9, the impact score of the “interested” reaction is about 110. This means that 110 more of the very positive respondents than the very negative respondents found at least a portion of the video content interesting. Similarly, the impact score of the “confused” reaction is about −30. This means that about 30 more of the very negative respondents than the very positive respondents found at least a portion of the video content confusing. The graph of FIG. 9 allows the pollster to quickly review the impact scores of the various reactions 204 and draw conclusions from which reactions the very positive and very negative respondents had. The graph of FIG. 9 implies, for example, that the very positive respondents enjoyed the video content because they found it interesting, while the very negative respondents disliked the video content because they found it confusing. In an alternative embodiment (not depicted), each of the impact scores may be normalized by sample size by dividing each of the impact scores by the total number of respondents. Normalizing the sample size allows impact scores measured from differently sized groups of respondents to more accurately be compared to each other. Although in the present embodiment the very positive respondents are classified as those who responded that they enjoyed the content by reporting a score greater than or equal to 7 and the very negative respondents are classified as those who responded that they disliked the content by reporting a score less than or equal to 3, the very positive and very negative respondents can be those who report enjoying the content by reporting a score exceeding any suitable positive threshold and those who report disliking the content by reporting a score exceeding any suitable negative threshold.

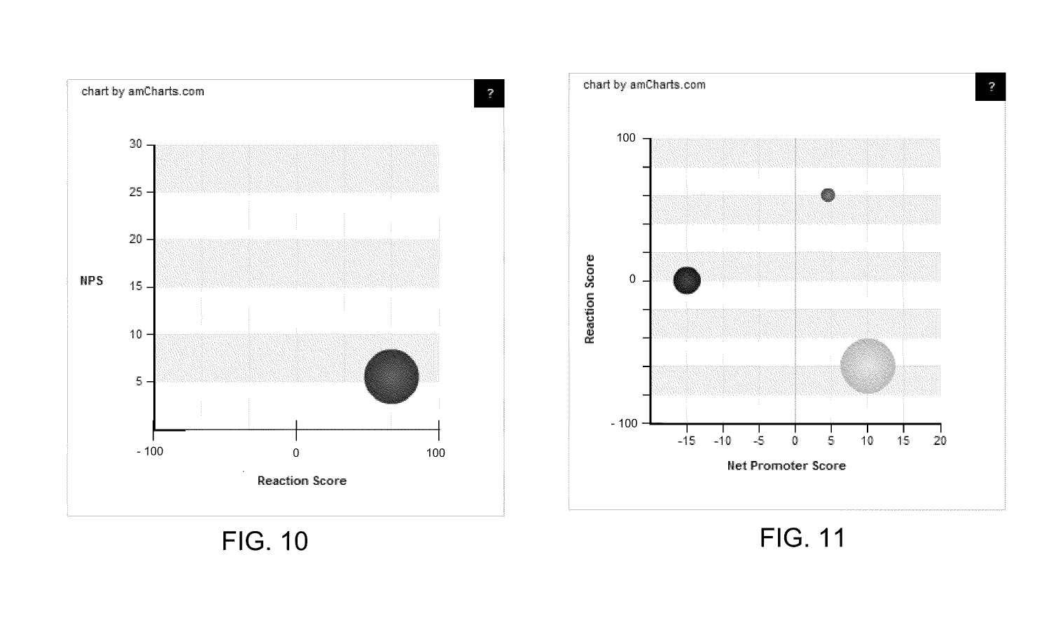

Referring now to FIG. 10, there is depicted a graph of the net promoter score vs. a “reaction score”. A reaction score is a single score representing how strong of an overall reaction the content elicits from the respondents. The reaction score is normalized such that it is between −100 and 100. A reaction score of 0 indicates that the respondents, on average, have neutral feelings about the content; a reaction score of 100 indicates that the respondents, on average, have very strong positive feelings about the content; and a reaction score of −100 indicates that the respondents, on average, have very strong negative feelings about the content. To calculate the reaction score, the number of times each of the reactions 204 was selected is multiplied by the impact score for that reaction 204, where the impact score is normalized by the number of respondents. The results of this multiplication for each of the reactions 204 are then summed, and this sum is normalized by the total number of respondents to determine the reaction score. By graphing the net promoter score against the reaction score, the pollster can graphically quickly determine whether the respondents, on average, liked or disliked the content, and whether the respondents are likely to recommend the content to others. For example, in the graph of FIG. 10 the reaction score is relatively high, which means that the respondents generally liked the content; however, the net promoter score is relatively low, which means that it is unlikely many of the respondents will recommend the content to others. The size of indicator marking the reaction score on the graph represents the number of respondents in the sample. In FIGS. 10 and 11, the indicator marking the reaction score is a dot.

FIG. 11 is a graph of reaction score vs. net promoter score. However, the graph of FIG. 11 shows three reaction scores, one for each segment of the respondents. In the graph of FIG. 11, the rightmost dot represents those respondents who frequently consume the content; the leftmost dot represents those respondents who occasionally consume the content; and the topmost dot represents those respondents who rarely or never consume the content. The feedback question 300 depicted in FIG. 5 is used to classify the respondents according to how frequently they consume the content. For example, those respondents who respond to the question of FIG. 5 by answering “Every day” or “Most days” are identified as frequent consumers; those respondents who respond by answering “Less often than once a month” or “Never” are those who rarely or never consume the content; and the remaining respondents are identified as occasional consumers. By segmenting the respondents according to frequency of consumption, the pollster can see how frequency of content consumption influences like or dislike of the content. In the graph of FIG. 11, for example, those respondents who most often viewed the type of content they evaluated were least likely to enjoy it.

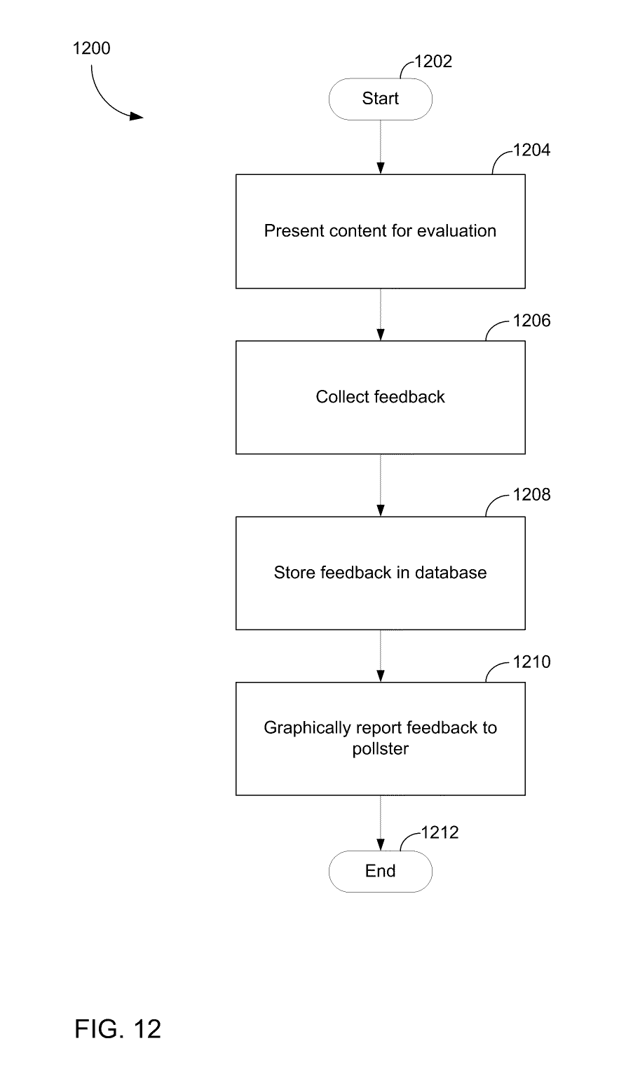

Referring now to FIG. 12, there is depicted a method 1200 for evaluating content, according to another embodiment. The method 1200 is implemented using the embodiment of the system 100, described above. At block 1202, the method begins. At block 1204, the collection server 106 presents to the respondents the content for evaluation. The content can be displayed using the feedback collection device 116. The respondents respond to the content by providing the feedback, which the collection server 106 collects at block 1206. The respondents can provide the feedback by clicking the reaction buttons 202 depicted in FIG. 2, and by answering the feedback questions 300 depicted in FIGS. 3 to 5. The collection server 106 stores the collected feedback in the collection database 108 at block 1208. When the pollster wishes to view reports summarizing the feedback, the reporting server 102 accesses the stored feedback in the collection database 108, agglomerates the feedback, and stores the agglomerated feedback in the reporting database 104. As discussed above in respect of the system 100, the feedback stored in the collection database 108 can be in the form of XML formatted strings, while the agglomerated feedback stored in the reporting database 104 can be in form of an agglomerated XML file generated from one or more of the XML formatted strings. The reporting server then graphically reports the feedback to the pollster at block 1210 using, for example, any of the graphs depicted in FIGS. 6 through 11. Following reporting of the feedback, the method ends at block 1212. The method 1200 of FIG. 12 can be encoded on the server memories 103, 107 contained within the servers 102, 106. Alternatively, the method 1200 of FIG. 12 can be encoded on any other suitable form of volatile or non-volatile computer readable medium, such as a computer memory or other storage medium, such as RAM (including non-volatile flash RAM and volatile SRAM or DRAM), ROM, EEPROM, and any other suitable semiconductor or disc-based media as is known to skilled persons. The method may be stored in the form of computer readable instructions stored in the medium that cause a computer processor to perform the method.

Variations of the foregoing embodiments are possible. For example, although two servers are depicted in FIG. 1, in an alternative embodiment the functionality of the system of FIG. 1 may be implemented using more than two servers or, alternatively, using only a single server communicatively coupled to a single database. The single server can perform the tasks of both the collection server 106 and the reporting server 102, and the single database can store what is stored in the reporting database 104 and the collection database 108.

In another alternative embodiment, a single network can be used in lieu of the separate WAN 114 and LAN 110 shown in FIG. 1. The pollster terminal 112 and the feedback collection devices 116 can both be communicatively coupled to this single network. Alternatively, in the embodiment of FIG. 1, the pollster terminal 112 can be used to access the reporting server 102 via the WAN 114, and the feedback collection devices 116 can be used to access the collection server 106 via the LAN 110.

Additionally, although the content that is primarily described in the foregoing embodiments is video content, in alternative embodiments the content may be audio content. For example, the viewing window 200 may be blank when audio content is being played, and the respondents may provide the feedback in the same way as when they are evaluating video content.

For the sake of convenience, the exemplary embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

While particular example embodiments have been described in the foregoing, it is to be understood that other embodiments are possible and are intended to be included herein. It will be clear to any person skilled in the art that modifications of and adjustments to the foregoing example embodiments, not shown, are possible.

1. A method for evaluating content, the method comprising:
(a) presenting the content for evaluation; and
(b) collecting feedback from a respondent using a feedback collection device that presents different kinds of reactions for selection during presentation of the content.

2. A method as claimed in claim 1 wherein the different kinds of reactions comprise different emotional reactions.

3. A method as claimed in claim 1 wherein the feedback collection device presents a prompt for binary feedback in the form of a presence or absence of one or more of the different kinds of reactions.

4. A method as claimed in claim 1 wherein the feedback collection device presents the content for evaluation.

5. A method as claimed in claim 1 wherein the content is one or both of audio and video content.

6. A method as claimed in claim 1 further comprising storing, in a database, a total number of times at least one of the different kinds of reactions was selected during presentation of a portion of the content.

7. A method as claimed in claim 6 further comprising graphically reporting the total number of times the at least one of the different kinds of reactions was selected during the portion of the content.

8. A method as claimed in claim 6 further comprising storing, in the database, a time at which the at least one of the different kinds of reactions was selected.

9. A method as claimed in claim 8 further comprising graphically reporting the number of times the at least one of the different kinds of reactions was selected during the portion of the content and at least one of the times at which the at least one of the different kinds of reactions was selected.

10. A method as claimed in claim 9 wherein graphically reporting at least one of the times at which the at least one of the different kinds of reactions was selected comprises:
(a) presenting the content; and
(b) as the content is being presented, displaying an indicator representative of selection of the at least one of the different kinds of reactions while the content that elicited the at least one of the different kinds of reactions is being presented.

11. A method as claimed in claim 10 further comprising after the content that elicited the at least one of the different kinds of reactions has passed, removing the indicator.

12. A method as claimed in claim 6 further comprising graphically reporting a reaction score, wherein the reaction score is determined according to a method comprising:
(a) for each of the different kinds of reactions, computing a product of a number of times the reaction was selected and a normalized impact score of the reaction, wherein the normalized impact score comprises a difference between a number of respondents who provided feedback indicating enjoyment of the content exceeding a positive threshold and another number of respondents who provided feedback indicating dislike of the content exceeding a negative threshold, normalized by a total number of respondents;
(b) generating a sum by summing the product for each of the different kinds of reactions together;
(c) normalizing the sum by the total number of respondents to determine the reaction score.

13. A system for evaluating content, the system comprising:
(a) a collection server configured to present the content for evaluation and to collect feedback from a respondent, wherein the feedback comprises different kinds of reactions selected during presentation of the content; and
(b) a collection database communicatively coupled to the collection server and configured to store the content and the feedback.

14. A system as claimed in claim 13 further comprising:
(a) a reporting server communicatively coupled to the collection server and configured to access the feedback and to generate a report summarizing the feedback; and
(b) a reporting database communicatively coupled to the reporting server and configured to store the report.

15. A system as claimed in claim 14 wherein the collection and reporting servers are one server, and the collection and reporting databases are one database.

16. A system as claimed in claim 13 wherein the different kinds of reactions comprise different emotional reactions.

17. A system as claimed in claim 13 wherein the feedback comprises binary feedback in the form of a presence or absence of one or more of the different kinds of reactions.

18. A system as claimed in claim 13 wherein the collection server is communicatively coupled to a feedback collection device configured to both collect the feedback and present the content for evaluation.

19. A system as claimed in claim 13 wherein the content is one or both of audio and video content.

20. A system as claimed in claim 14 wherein the reporting database has stored therein a total number of times at least one of the different kinds of reactions was selected during presentation of a portion of the content.

21. A system as claimed in claim 20 wherein the reporting database has stored therein a time at which the at least one of the different kinds of reactions was selected.

22. A system as claimed in claim 21 wherein the report comprises a graphic display of the number of times the at least one of the different kinds of reactions was selected during the portion of the content and at least one of the times at which the at least one of the different kinds of reactions was selected.

23. A system as claimed in claim 22 wherein the graphic display comprises:
(a) a presentation of the content; and
(b) during the presentation of the content, displaying an indicator representative of selection of the at least one of the different kinds of reactions while the content that elicited the at least one of the different kinds of reactions is being presented.

24. A system as claimed in claim 23 wherein the indicator is removed after the content that elicited the at least one of the different kinds of reactions has passed.

25. A system as claimed in claim 20 wherein the graphic display further comprises a reaction score, wherein the reporting server determines the reaction score according to a method comprising:
(a) for each of the different kinds of reactions, computing a product of a number of times the reaction was selected and a normalized impact score of the reaction, wherein the normalized impact score comprises a difference between a number of respondents who provided feedback indicating enjoyment of the content exceeding a positive threshold and another number of respondents who provided feedback indicating dislike of the content exceeding a negative threshold, normalized by a total number of respondents;
(b) generating a sum by summing the product for each of the different kinds of reactions together;
(c) normalizing the sum by the total number of respondents to determine the reaction score.

26. A computer readable medium having encoded thereon statements and instructions to cause a processor to execute a method for evaluating content, the method comprising:
(a) presenting the content for evaluation; and
(b) collecting feedback from a respondent using a feedback collection device that presents different kinds of reactions for selection during presentation of the content.
